(19) United States
(12) Patent Application Publication
(10) Pub. No.: US 2022/0076097 A1
(43) Pub. Date: Mar. 10, 2022

(54) NEURAL NETWORK COMPUTATION METHOD, DEVICE, READABLE STORAGE MEDIA AND ELECTRONIC EQUIPMENT

(71) Applicant: HORIZON (SHANGHAI) ARTIFICIAL INTELLIGENCE TECHNOLOGY CO., LTD., Shanghai (CN)

(72) Inventors: Zhuoran ZHAO, Shanghai (CN); Zhenjiang WANG, Shanghai (CN)

(73) Assignee: HORIZON (SHANGHAI) ARTIFICIAL INTELLIGENCE TECHNOLOGY CO., LTD., Shanghai (CN)

(21) Appl. No.: 17/468,136

(22) Filed: Sep. 7, 2021

(30) Foreign Application Priority Data
Sep. 7, 2020 (CN) 202010931842.4

(51) Int. Cl. G06N 3/04

(52) U.S. Cl. CPC G06N 3/04

(57) ABSTRACT

The present application discloses a neural network computation method includes determining the size of the first feature map obtained when the processor computes the present layer of the neural network before performing convolution computation on the next layer of the neural network; determining a convolution computation order of the next layer according to the size of the first feature map and the size of the second feature map for a convolution supported by the next layer; performing convolution computation instructions from the next layer based on the convolution computation order. Exemplary embodiments in the present disclosure decrease the interlayer feature map data access overhead and reduce the idle time of a computation unit by leaving out the storage of the first feature map and the loading process of the second feature map.

### CROSS-REFERENCE TO RELATED APPLICATIONS

This application claims a benefit of and priority to Chinese Patent Application No. 202010931842.4 filed on Sep. 7, 2020, the disclosure of which is hereby expressly incorporated in its entirety by reference herein.

### TECHNICAL FIELD

The present disclosure relates to the field of neural network computation, especially relates to a neural network computation method, a neural network computation device, a readable storage media and an electronic equipment.

### BACKGROUND

A deep neural network dedicated accelerator is designed for processing the deep neural network inference with high efficiency, which is commonly embedded into an on-chip processor system (SoC) of an instrument. In order to decrease chip area overhead and power dissipation, it usually contains an on-chip cache system and a large-scale multiply and add array (MAC). The on-chip cache runs very fast but its capacity is generally small, which disables it from caching all feature maps and weight data. The computations for neural network layers are commonly divided into a number of mini computation subtasks and the feature maps are also cut into a lot of small feature maps being small enough to be completely loaded by on-chip cache. The original feature map is commonly stored in an off-chip memory (DDR) with a large space but a slow speed. Upon the start of each computation period, a part of the feature map is firstly loaded into the on-chip cache, then it is subjected to computation and finally it is stored back into an off-chip memory. A computation unit are idle when data is read from and written into an off-chip memory.

### SUMMARY

In order to solve the above-mentioned technical problems, the present disclosure is proposed. Embodiments of the present disclosure provide a neural network computation method, a neural network computation device, a readable storage media and an electronic equipment, which can decrease the interlayer consumption of a neural network and improve the computation efficiency.

According to one aspect of the present disclosure, a neural network computation method is provided. The neural network computation method includes determining a size of a first feature map obtained when a processor performs a convolution computation on a current layer of a neural network before a convolution computation on a next layer in the neural network is performed; determining a convolution computation order of the next layer according to the size of the first feature map and a size of a second feature map for a convolution supported by the next layer; and performing convolution computation instructions for the next layer based on the convolution computation order.

According to a second aspect of the present disclosure, a neural network computation device is provided. The device includes a data acquisition module used for determining a size of a first feature map obtained when a processor performs a convolution computation on a current layer of a neural network before performing a convolution computation on a next layer in the neural network; a task sequencing module used for determining a convolution computation order of the next layer according to the size of the first feature map and a size of a second feature map for a convolution supported by the next layer; and a computation execution module used for performing convolution computation instructions for the next layer based on the convolution computation order.

According to a third aspect of the present disclosure, a computer readable storage media is provided, wherein the storage media stores computer programs used for performing any above-mentioned method of decreasing of interlayer time delay of a neural network.

According to a fourth aspect of the present disclosure, an electronic equipment is provided. The electronic equipment includes a processor; and a memory used for storing instructions executable by the processor; wherein the processor is used for reading the executable instructions from the memory and performing any method of decreasing interlayer time delay of a neural network.

In the four technical solutions provided in the present disclosure, when the convolution computation on the next layer in the neural network is performed, the convolution order for the next layer is adjusted according to the size of the first feature map output from the current layer and the size of the second feature map for the convolution supported by the next layer; and upon the start of the convolution computation for the next layer, the feature map currently stored on an on-chip cache is firstly acquired for computation so as to save the step of transmitting the feature map to the on-chip cache from an off-chip memory at the beginning of computation for the next layer and decrease the interlayer feature map data access overhead.

### BRIEF DESCRIPTION OF THE DRAWINGS

By explaining embodiments of the present disclosure with more details in combination with drawings, the above-mentioned and other purposes, features and advantages of the present disclosure will be more apparent. Drawings are used to provide a further understanding for embodiments of the present disclosure and constitute parts of the specification, which are used together with embodiments of the present disclosure to interpret the present disclosure and should not constitute limits to the present disclosure. In the drawings, the same reference marks generally represent the same members or steps.

FIG. 1 is a scene graph or system graph where the present disclosure is applicable to.

FIG. 2 is a flow chart of a neural network computation method provided by an exemplary embodiment of the present disclosure.

FIG. 3 is a flow chart provided by another exemplary embodiment of the present disclosure, wherein a size of a first feature map is bigger than a size of a second feature map.

FIG. 4 is a schematic diagram showing the division for a first feature map in a neural network computation method provided by another exemplary embodiment of the present disclosure.

FIG. 5 is a flow chart of a neural network computation method provided by another exemplary embodiment of the present disclosure, wherein a size of a first feature map is smaller than a size of a second feature map.

FIG. 6 is a schematic diagram of a neural network computation method provided by another exemplary embodiment of the present disclosure, wherein the first feature map and the second feature map are merged.

FIG. 7 is a flow chart of a neural network computation method provided by another exemplary embodiment of the present disclosure, wherein a size of a first feature map is reduced.

FIG. 8 is a flow chart of a neural network computation method provided by another exemplary embodiment of the present disclosure, wherein a size of a first feature map is enlarged.

FIG. 9 is a flow chart for subsequent sequencing in a neural network computation method provided by another exemplary embodiment of the present disclosure.

FIG. 10a is a schematic diagram for the storage and loading of a interlayer feature map in the prior art.

FIG. 10b is a schematic diagram for the storage and loading of a interlayer feature map of a neural network computation method provided by another exemplary embodiment of the present application, wherein a size of a first feature map is bigger than a size of a second feature map.

FIG. 10c is a schematic diagram for the storage and loading of a interlayer feature map of a neural network computation method provided by another exemplary embodiment of the present application, wherein a size of a first feature map is smaller than a size of a second feature map.

FIG. 10d is a schematic diagram for the storage and loading of a interlayer feature map of a neural network computation method provided by another exemplary embodiment of the present application, wherein a size of a first feature map is equal to a size of a second feature map.

FIG. 11 is a flow chart of a neural network computation device provided by one exemplary embodiment of the present application.

FIG. 12 is a schematic diagram of a task sequencing module of a neural network computation device provided by another exemplary embodiment of the present disclosure.

FIG. 13 is a schematic diagram of a task sequencing module of a neural network computation device provided by another exemplary embodiment of the present disclosure.

FIG. 14 is a schematic diagram of a task sequencing module of a neural network computation device provided by another exemplary embodiment of the present disclosure.

FIG. 15 is a schematic diagram of a data acquisition module of a neural network computation device provided by another exemplary embodiment of the present disclosure.

FIG. 16 is a schematic diagram of a data acquisition module of a neural network computation device provided by another exemplary embodiment of the present disclosure.

FIG. 17 is a schematic diagram of a neural network computation device provided by another exemplary embodiment of the present disclosure.

FIG. 18 is a schematic diagram of a neural network computation device provided by another exemplary embodiment of the present disclosure.

FIG. 19 is a structure diagram of an electronic equipment provided by an exemplary embodiment of the present application.

### DETAILED DESCRIPTION

Now exemplary embodiments according to present disclosure are described in details by referring to drawings hereinafter. It is obvious that the described embodiments are only part of embodiments in the present disclosure rather than all the embodiments of the present disclosure. It should be understood that the present disclosure is not limited by exemplary embodiments described herein.

### Summary of the Present Application

As described above, since reading from and writing to an off-chip memory will cause the idleness of a computation unit and result in a waste of resources, there are some technical solutions where functions of the computation module and of the data transmitting module are separated so that the data transmitting module can synchronously cache data of the next subtask and the alternative execution of the computation and the data transmission between small computation tasks inside of deep neural network layers can be realized when the computation module computes the current subtask. However, shortcomings of the above-mentioned dividing and optimizing method lie in that only inner-layer subtasks are taken into consideration while subtasks between two layers are independent with each other, which means that the bottleneck of computation may lie in the failure of optimization of the feature map data access overhead between layers when an extremely deep neural network is computed.

The present disclosure adjusts the convolution order of a next layer in a neural network based on the above-mentioned problems, as a result, firstly the next layer acquires the feature map output from a current layer in the neural network from an on-chip cache unit upon the start of computation, so as to decrease the feature map data access overhead between layers.

Specifically speaking, as the feature map output from the current layer in the neural network may have a size different from that of the feature map for a convolution supported by the next layer, the convolution order of the next layer needs to be determined according to the sizes of the both to the next layer.

That allows the next layer in the neural network to acquire the feature map from the on-chip cache rather than from the off-chip memory upon the start of computation so as to decrease the interlayer feature map data access overhead and avoid the idleness and waste of computation resource.

### Exemplary System

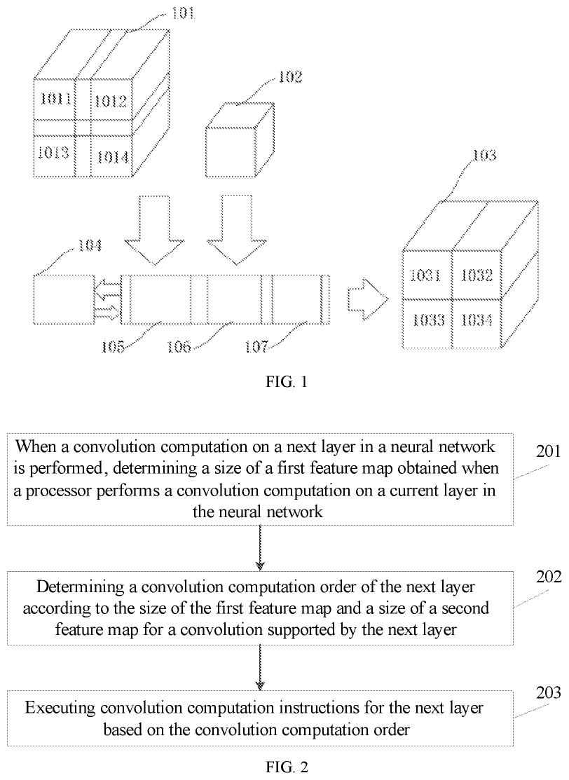

FIG. 1 shows an exemplary system. As shown in the figure, due to the limited memory capacity of an on-chip cache, not all the original feature maps can be stored in the on-chip cache. The original feature map 101 for layer L₀ is respectively divided for once in the horizontal direction and the vertical direction, into four feature maps, which are feature map 1011, feature map 1012, feature map 1013 and feature map 1014 respectively according to the manner from left to right and from top to bottom and are loaded and computed sequentially according to an order from left to right and from top to bottom during the computation. The computation process of the feature map 1011 is employed as an example. The feature map 1011 is loaded into a feature over-provisioning 105 in an on-chip cache unit from an off-chip memory 104 and the convolution kernel 102 is loaded into a weight over-provisioning 106 in the on-chip cache unit. A multiply and add array multiplies and adds the feature map 1011 in the feature over-provisioning and the convolution kernel in the weight over-provisioning to get the computed feature map 1031 for L₁ layer, and stores it in a output over-provisioning 107, finally transmits the feature map in the output over-provisioning into the off-chip memory. When all computations on the four feature maps are completed, the original feature map 103 for L₁ layer is formed. At this time, the original feature map for L₁ layer includes four feature maps, i.e. feature map 1031, feature map 1032, feature map 1033 and feature map1034.

### Exemplary Method

FIG. 2 shows a neural network computation method provided by one exemplary embodiment of the present application. The present embodiment can be applied to an electronic equipment, and as shown in FIG. 2, it includes the following steps:

Step 201: when a convolution computation on a next layer in a neural network is performed, determining a size of a first feature map obtained when a processor performs a convolution computation on a current layer in the neural network;

The size of the first feature map means the size of the feature map output after the computation on the current layer. In some embodiments, the size of the first feature map means the size of the feature map output from the output over-provisioning in FIG. 1.

Step 202: determining a convolution computation order of the next layer according to the size of the first feature map and a size of a second feature map for a convolution supported by the next layer;

The size of the second feature map means an input size supported when the convolution on the next layer in the neural network is performed. In some embodiments, the size of the second feature map means the size of each feature map after the division of the original feature map for layer L₁.

Step 203: executing convolution computation instructions for the next layer based on the convolution computation order.

The computation order means the order of performing convolutions on the divided feature maps. In some embodiments, by using the above-mentioned layer L₀ as a previous layer in a neural network, using layer L₁ as a next layer in the neural network, a convolution computation order of the next layer in the neural network is that the feature map stored in the storage provisioning can be firstly performed convolution computation after the computation on the previous layer in the neural network. As the first feature map is still stored in the memory provisioning of an on-chip cache unit and not yet stored into an off-chip memory at this time, there is no need to transmit the first feature map into the off-chip memory during the processing of the current layer in the neural network and there is no need to transmit the first feature map into the on-chip cache unit from the off-chip memory either during the processing of the next layer in the neural network, which can save the interlayer feature map data access overhead and reduce the idle time of a computation unit.

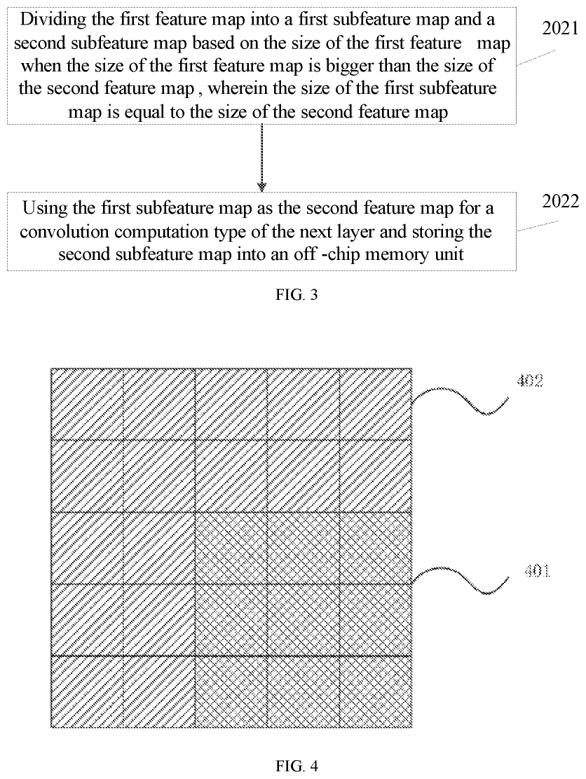

As shown in FIG. 3, based on the above-mentioned embodiment shown in FIG. 2, step 202 can include the following steps:

Step 2021: dividing the first feature map into a first subfeature map and a second subfeature map based on the size of the first feature map when the size of the first feature map is bigger than the size of the second feature map, wherein the size of the first subfeature map is equal to the size of the second feature map;

In some embodiments, the size of the first feature map is bigger than the size of the second feature map. For example, the first feature map has a size of 5*5 while the second feature map has a size of 3*3. At this time, as the next layer in the neural network does not support the feature map with a size of 5*5, the first feature map needs to be divided. In some embodiments, the division results are shown in FIG. 4 and the first feature map has a size of 5*5. At this time, the first feature map is divided into a first subfeature map 401 and a second subfeature map 402, wherein the first subfeature map 401 has a size of 3*3 while the second feature map becomes one formed from the remained two lines and two columns. In some embodiments, in order to facilitate computations of other second feature maps on the next layer, selections can be made that the right margin of the first subfeature map 401 acts as the right margin of the first feature map and the lower margin of the first subfeature map 401 acts as the lower margin of the first feature map.

Step 2022: using the first subfeature map as the second feature map for a convolution computation type of the next layer and storing the second subfeature map into an off-chip memory unit.

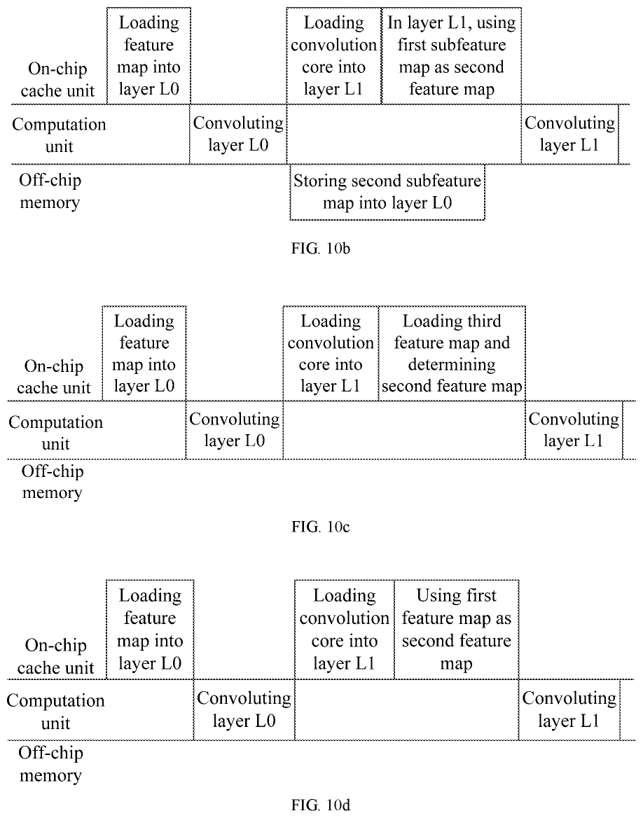

In some embodiments, the first subfeature map is stored in the on-chip cache unit and the second subfeature map is stored in the off-chip memory so as to allow the second subfeature map to be involved in the subsequent division process of feature maps. The first subfeature map is stored in the on-chip cache unit at this time and the first subfeature map acts as the second feature map to start the convolution on the next layer, which realizes that the procedure of transmitting the first subfeature map into the off-chip memory is left out during processing a previous layer of the neural network and the procedure of transmitting the first subfeature map into the on-chip cache unit from the off-chip memory is left out during processing the next layer in the neural network, thereby saving the interlayer access data overhead and reducing the idle time of the computation unit. FIGS. 10a and 10b are comparative figures between the execution process in the prior art and that in an exemplary embodiment of the present disclosure. In the prior art, as shown in FIG. 10a, after all convolution computations on the previous layer of the neural network are completed, all the output first feature map are stored into the off-chip memory, and upon the start of computation on the next layer, the convolution kernel of the next layer, i.e. the weight of the next layer or the second feature map of the next layer is loaded from the off-chip memory into the on-chip cache unit, then the computation starts. With regard to this computation method, in the process where the feature map for a last convolution subtask in the previous layer is stored into the off-chip memory and in the process where the first convolution subtask in the next layer is loaded into the second feature map from the off-chip memory, the computation unit are idle. In contrast, in the exemplary embodiments in the present disclosure, the first subfeature map stored in the on-chip cache unit after a computation is directly adopted as the second feature map to start the computation on the first convolution subtask of the next layer, which leaves out the process of storing into and loading from the first subfeature map and reduces the feature map data access overhead for the first subfeature map to be stored into the off-chip memory from the on-chip cache unit and the second feature map to be loaded into the on-chip cache unit from the off-chip memory.

As shown in FIG. 5, based on the above-mentioned embodiment shown by the FIG. 2, step 202 can include the following steps:

Step 2023: loading a third feature map in a domain adjacent to the first feature map from an off-chip memory when the size of the first feature map is smaller than the size of the second feature map;

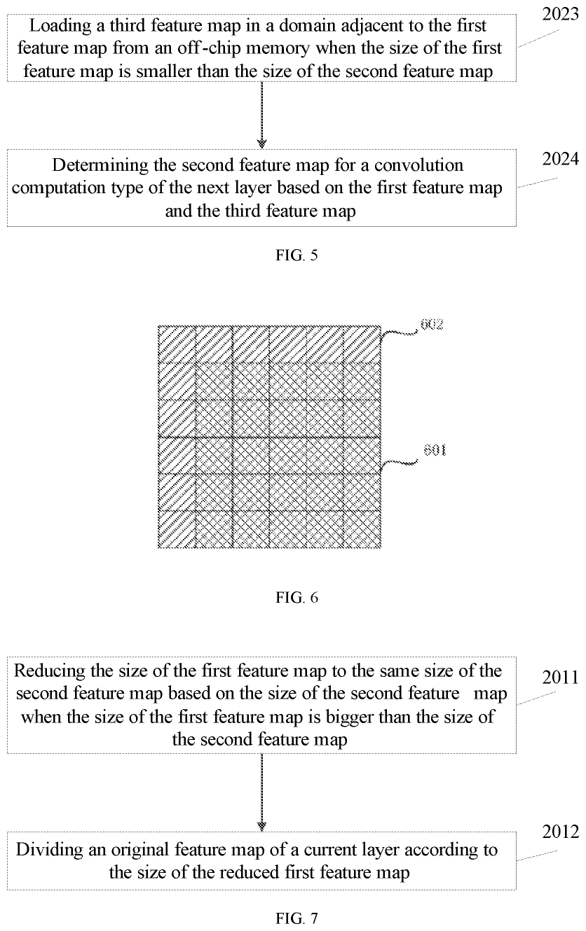

In some embodiments, the size of the first feature map is smaller than the size of the second feature map. For example, as shown in FIG. 6, the first feature map has a size of 5*5 while the second feature map has a size of 6*6. At this time, the size of a first feature map for the previous layer does not meet the convolution size of a second feature map for the convolution supported by the next layer, which means a third feature map lying in a line above the first feature map and a column on the left of the first feature map needs to be loaded from the off-chip memory.

Step 2024: determining the second feature map for a convolution computation type of the next layer based on the first feature map and the third feature map.

In some embodiments, after the third feature map is loaded from the off-chip memory, data of the third feature map and data of the first feature map are merged so as to form the second feature map that complies with the convolution condition. For example, at least one line adjacent to the upper margin and at least one column adjacent to the left margin of the first feature map are loaded from an off-chip memory and act as the third feature map which fills the upper side and left side of the first feature map so as to form the second feature map. As exemplified in FIG. 6, a first feature map 601 with a size of 5*5 is used, and a line above the first feature map 601 and a column on the left of the first feature map 601 are loaded from the off-chip memory and then act as a third feature map 602. The third feature map 602 and the first feature map 601 are merged to form the second feature map with a size of 6*6. At this time, this feature map can be subjected to convolution since it complies with the convolution condition of the next layer. FIG. 10a and FIG. 10c are comparative figures of execution processes between the prior art and exemplary embodiment of the present disclosure. Similar to the above-mentioned step 2022, the present patent application also leaves out procedures where the first feature map 601 is transmitted to the off-chip memory from the on-chip cache unit and transmitted to the on-chip cache unit from the off-chip memory, which enables it to decrease the interlayer feature map data access overhead and reduce the idle time of the computation unit.

Based on the above-mentioned embodiment shown in FIG. 2, step 202 can include following steps:

Step 2025: using the first feature map as the second feature map for a convolution computation type of the next layer when the size of the first feature map is equal to the size of the second feature map.

In some embodiments, the first feature map and the second feature map have the same size, under which circumstance, the first feature map meets the convolution condition of the next layer, which means the first feature map will be used as the second feature map directly to convolute. At this time, there is no need to store the first feature map output after convolution on the previous layer into the off-chip memory and there is no need to load the second feature map upon the start of convolution on the next layer, which saves the interlayer feature map data access overhead and improves the computational efficiency. Comparison between the execution processes of the exemplary embodiment of the present disclosure and the prior art can be referred to FIG. 10a and FIG. 10d.

Based on the above-mentioned embodiment shown in FIG. 2, as shown in FIG. 7, step 201 can include following steps:

Step 2011: reducing the size of the first feature map to the same size of the second feature map based on the size of the second feature map when the size of the first feature map is bigger than the size of the second feature map;

In some embodiments, the size of the first feature map is bigger than the size of the second feature map. For example, the first feature map is one default with a size of 5*5 while the second feature map is one with a size of 3*3; at this time, as the next layer in the neural network does not support a feature map with a size of 5*5, the way in the present step can also be adopted apart from the above-mentioned processing way in step 2021. That is, before the division of the first feature map of the current layer, the size of the second feature map supported by the computation on the next layer is inquired firstly, for example, the above-mentioned feature map with a size of 3*3. If the convolution computation of the current layer can both support the feature map with a default size of 5*5 and the feature map with a size of 3*3, the feature map with a size of 3*3 can act as the first feature map for the current layer.

Step 2012: dividing an original feature map of a current layer according to the size of the reduced first feature map.

In some embodiments, the above-mentioned way reduces the size of the first feature map. After reduction, an original feature map is divided. At this time, the divided first feature map and the second feature map have the same size and the method in the above-mentioned step 2025 can sort the convolution order of the feature maps. In the present step, since the first feature map is reduced to one with the same size to the second feature map, the procedure of storing the second subfeature map into the off-chip memory is left out, which can further decrease the interlayer feature map data access overhead and can reduce the idle time of the computation unit.

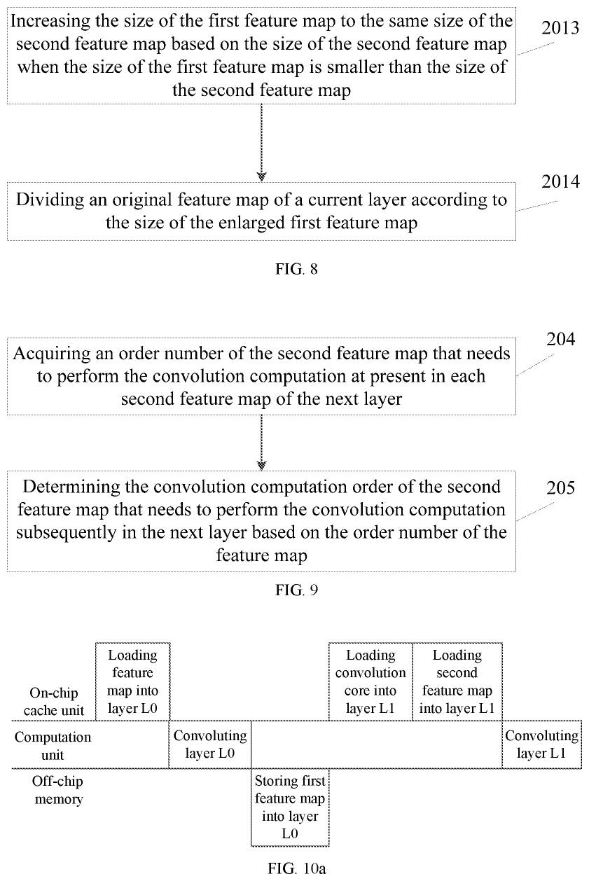

Based on the above-mentioned embodiment shown in FIG. 2, as shown in FIG. 8, step 201 can include following steps:

Step 2013: increasing the size of the first feature map to the same size of the second feature map based on the size of the second feature map when the size of the first feature map is smaller than the size of the second feature map;

In some embodiments, the size of the first feature map is smaller than the size of the second feature map. For example, the first feature map has a default size of 5*5 and the second feature map has a size of 6*6. At this time, the size of the first feature map output from the previous layer does not meet the convolution size of the second feature map for the convolution supported by the next layer. The way in the present step can also be adopted apart from the above-mentioned processing way in step 2023. Namely, before the division of the first feature map of the current layer, the size of the second feature map supported by the computation on the next layer is inquired firstly, for the example the above-mentioned feature map with a size of 6*6. If the convolution computation of the current layer can both support the feature map with a default size of 5*5 and the feature map with a size of 6*6, the feature map with a size of 6*6 can act as the first feature map for the current layer.

Step 2014: dividing an original feature map of a current layer according to the size of the enlarged first feature map.

In some embodiments, the size of the first feature map is increased with the above-mentioned way. After the increase of the size of the first feature map, the original feature map is divided. At this time, the divided first feature map has the same size as the second feature map and the above-mentioned method in step 2025 can sort the convolution order of feature maps. In the present step, since the size of the first feature map is increased to the same size as that of the second feature map, the procedure of loading the third feature map from an off-chip memory is left out, which can further decrease the interlayer feature map data access overhead and can reduce the idle time of a computation unit.

Based on the above-mentioned embodiment shown in FIG. 2, the method can include following steps after step 201:

Step 2010: storing the first feature map into an on-chip cache unit.

In some embodiments, since the first feature map needs to be stored into the on-chip cache unit during the process of convolution computation, while an original feature map and an output feature map will be stored in the off-chip memory. In order to store the first feature map into the on-chip cache unit, an instruction of storing the first feature map into the on-chip cache unit is executed to avoid that the first feature map is stored into the off-chip memory.

As shown in FIG. 9, based on the above-mentioned embodiment shown in FIG. 2, following steps can be further included:

Step 204: acquiring an order number of the second feature map that needs to perform the convolution computation at present in each second feature map of the next layer;

In some embodiments, in order to decrease the interlayer access overhead, the first feature map means a first feature map output by the last executed convolution subtask in the current layer, while the second feature map means a second feature map output by the firstly executed convolution subtask in the next layer. The order number means the input of which convolution subtask corresponding to the second feature map in the next layer.

Step 205: determining the convolution computation order of the second feature map that needs to perform the convolution computation subsequently in the next layer based on the order number of the feature map.

In some embodiments, the execution sequence for subtasks of layer L₀ is one where multiple feature maps are sequentially executed from left to right and from top to bottom. At this time, when the last subtask of layer L₀ is executed, it is required that the feature map in the lower right corner is convoluted and the first feature map of the last subtask is output after the convolution. At this time, the first executed subtask of layer L₁ is to perform the convolution by switching the first feature map in the lower right corner into the second feature map. After the execution of the first subtask is completed, the subsequent subtasks can convolute either in an inverse order from right to left and from bottom to top or in a random order.

In the above-mentioned exemplary embodiments, no matter what a subsequent convolution computation order is, as long as the first feature map output by the last convolution computation subtask of the previous layer acts as the second feature map for the first convolution computation subtask of the next layer by dividing or filling, or directly acts as the second feature map of the first convolution computation subtask of the next layer, the storage and loading process of the first feature map can be left out and the idle time of the computation unit can be reduced. For example, still taking the computation in FIG. 1 as an example, during the computation of the current layer, the convolution order is in an order of feature maps 1011,1012,1013 and 1014, and the output order is in an order of feature maps 1031,1032,1033 and 1034. Upon the computation on the next layer, there are three optional computation orders, first of which is reverse to the order performing the computation in the current layer, i.e. in an order of feature maps 1034,1033,1032 and 1031; second of which is the feature map 1034 is firstly computed and then other feature maps still in the original outputting order are computed, i.e. the whole computation order is in an order of feature maps 1034,1031,1032 and 1033; and third of which is the feature map 1034 is firstly computed and then other feature maps are computed in a random order. Actually, the feature map 1034 output when computing the feature map 1014 of the current layer should be firstly computed in any computation order for the feature map 1034 is the last feature map in the current layer that is stored in the output over-provisioning 107. At this time, the computation on this feature map can be continued, which saves the procedure of storing this feature map into the off-chip memory and then loading it into the on-chip cache from the off-chip memory, saving the feature map data access overhead and reducing the idle time of the computation unit. In contrast, other feature maps have been stored into the off-chip memory. For example, during the process of performing convolution computation on the feature map 1014, the feature map 1033 is stored into the off-chip memory from the output over-provisioning 107 of the on-chip cache, which reserves enough space for storing the feature map 1034.There is a need to acquire the order number of the current feature map in the computation process based on the above-mentioned several computation orders, so as to sort the subsequent convolution computation. For example, when performing the convolution computation with the first way, the feature map for the current convolution is the feature map 1033 and its order number is second, which means the feature map to compute subsequently is the feature map 1032.

### Exemplary Device

FIG. 11 shows a neural network computation device provided by one exemplary embodiment of the present disclosure. The present embodiment can be applied to an electronic equipment. As shown in FIG. 11, the neural network computation device includes the following modules:

A data acquisition module 901 used to determine a size of a first feature map obtained by means of a convolution computation, via a processor, on a current layer in a neural network when performing convolution computation on a next layer in the neural network;

The size of the first feature map means the size of an output feature map after the computation on the current layer. In some embodiments, the size of the first feature map means the size of the feature map output from the output over-provisioning in FIG. 1.

A task sequencing module 902 used to determine a convolution computation order of the next layer according to the size of the first feature map and a size of a second feature map for a convolution supported by the next layer;

The size of the second feature map means an input size supported when the convolution on the next layer in the neural network is performed. In some embodiments, the size of the second feature map means the size of each feature map after the division of an original feature map for layer L₁.

A computation execution module 903 used to execute convolution computation instructions for the next layer based on the convolution computation order.

The computation order means an order of performing convolution on the divided feature maps. In some embodiments, the above-mentioned layer L₀ may be acted as a previous layer in the neural network, and layer L₁ is acted as the next layer in the neural network, for a convolution computation order of the next layer in the neural network, the feature map stored in the storage provisioning after the computation on the previous layer in the neural network can be firstly computed. As the first feature map is still stored in the storage provisioning of an on-chip cache unit and not yet stored in an off-chip memory at this time, there is no need to transmit the first feature map into the off-chip memory during the processing of the current layer in the neural network, and there is no need to transmit the first feature map into the on-chip cache unit from the off-chip memory either during the processing of the next layer in the neural network, which can save the interlayer feature map data access overhead and reduce the idle time of a computation unit.

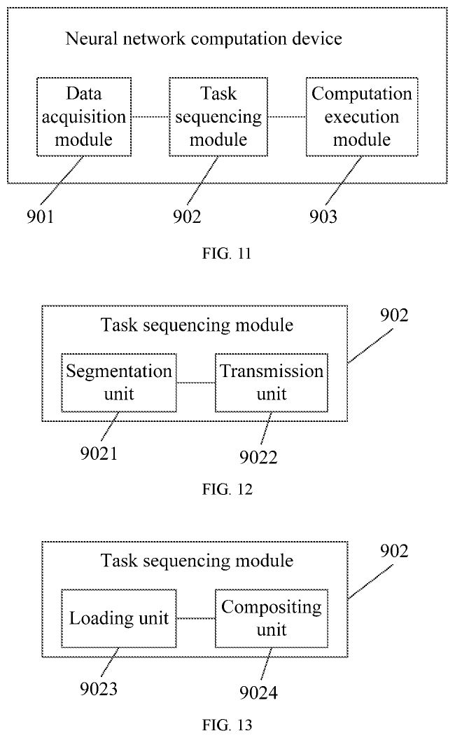

As shown in FIG. 12, based on the above-mentioned embodiment shown in FIG. 11, the task sequencing module 902 can include the following units:

A segmentation unit 9021 used to divide the first feature map into a first subfeature map and a second subfeature map based on the size of the first feature map when the size of the first feature map is bigger than the size of the second feature map, wherein a size of the first subfeature map is equal to the size of the second feature map;

In some embodiments, the size of the first feature map is bigger than the size of the second feature map. For example, the first feature map has a size of 5*5 while the second feature map has a size of 3*3; at this time, as the next layer in a neural network does not support the feature map with a size of 5*5, the first feature map needs to be divided. In some embodiments, the division results are shown in FIG. 4, and the first feature map has a size of 5*5, and at this time, is divided into a first subfeature map 401 and a second subfeature map 402, wherein the first subfeature map 401 has a size of 3*3 and the second feature map becomes one formed from the remained two lines and two columns. In some embodiments, in order to facilitate computations on other second feature maps of the next layer, selections can be made that the right margin of the first subfeature map 401 acts as the right margin of the first feature map and the lower margin of the first subfeature map 401 acts as the lower margin of the first feature map.

A transmission unit 9022 used to take the first subfeature map as the second feature map for a convolution computation type of a next layer and store the second subfeature map into an off-chip memory unit.

In some embodiments, the first subfeature map is stored in an on-chip cache unit and the second subfeature map is stored in an off-chip memory so as to allow the second subfeature map to be involved in the division process of subsequent feature maps. The first subfeature map is stored in the on-chip cache unit at this time and acts as the second feature map to start the convolution on the next layer, which realizes that the procedure of transmitting the first subfeature map into the off-chip memory is left out in the processing of a previous layer of the neural network and the procedure of transmitting the first subfeature map into the on-chip cache unit from the off-chip memory is left out in the processing of the next layer in the neural network, saving the interlayer access data overhead and reducing the idle time of the computation unit. FIG. 10a and FIG. 10b are comparative figures between the execution process in the exemplary embodiment of the present disclosure and in the prior art. In the prior art, as shown in FIG. 10a, after all convolution computations on the previous layer of the neural network are completed, all the output first feature maps are stored into the off-chip memory, and upon the start of computation on the next layer, the convolution kernel of the next layer, i.e. the weight of the next layer or the second feature map of the next layer is loaded from the off-chip memory into the on-chip cache unit, after which the computation starts. With regard to this computation method, in the process where the feature map for a last convolution subtask in the previous layer is stored into the off-chip memory and in the process where the first convolution subtask in the next layer is loaded into the second feature map from the off-chip memory, the computation unit is idle. On the contrary, in the exemplary embodiment of the present disclosure, the first subfeature map stored in the on-chip cache unit after the computation is directly adopted as the second feature map to start the computation on the first convolution subtask of the next layer, which leaves out the process of storing and loading the first subfeature map and reduces the feature map data access overhead.

As shown in FIG. 13, based on the above-mentioned embodiment shown in FIG. 11, the task sequencing module 902 can include the following units:

A loading unit 9023 used to load a third feature map in a domain adjacent to the first feature map from an off-chip memory when the size of the first feature map is smaller than the size of the second feature map;

In some embodiments, the size of the first feature map is smaller than the size of the second feature map. For example, as shown in FIG. 6, the first feature map has the size of 5*5 while the second feature map has the size of 6*6. At this time, the size of the first feature map for the previous layer does not meet the convolution size of the second feature map for the convolution supported by the next layer, which means the third feature map which lies in a line above and a column on the left of the first feature map needs to be loaded from the off-chip memory.

A compositing unit 9024 used to determine the second feature map for the convolution computation type of the next layer based on the first feature map and the third feature map.

In some embodiments, after the third feature map is loaded from the off-chip memory, data of the third feature map and data of the first feature map are merged so as to form the second feature map that complies with the convolution condition. For example, as shown in FIG. 6, a first feature map 601 with a size of 5*5 is used, and a line above and a column on the left of the first feature map 601 are loaded and act as a third feature map 602, then the third feature map 602 and the first feature map 601 are merged to form the second feature map with a size of 6*6. At this time, this map can be subjected to convolution if it complies with the convolution condition of the next layer. FIG. 10a and FIG. 10c are comparative figures of execution processes between the prior art and the exemplary embodiment of the present disclosure. Similar to the above-mentioned step 2022, the present patent application also leaves out procedures where the first feature map 601 is transmitted to the off-chip memory from the on-chip cache unit and transmitted to the on-chip cache unit from the off-chip memory, which decreases the interlayer data overhead and reduces the idle time of the computation unit.

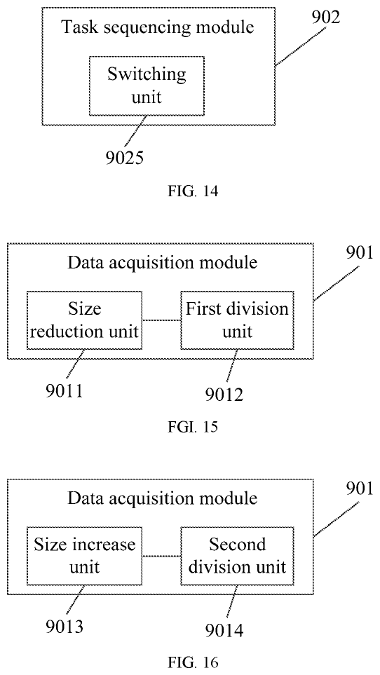

As shown in FIG. 14, based on the above-mentioned embodiment shown in FIG. 11, the task sequencing module 902 can include following units:

A switching unit 9025 used to switch the first feature map into the second feature map for a convolution computation type of the next layer when the size of the first feature map is equal to the size of the second feature map.

In some embodiments, the first feature map and the second feature map have the same size. Under this circumstance, the first feature map meets the convolution condition of the next layer, which means the first feature map will be used as the second feature map directly for the convolution. At this time, there is no need to store the first feature map output after the convolution on the previous layer into the off-chip memory and there is no need to load the second feature map upon the start of convolution of the next layer, which saves the interlayer feature map data access overhead and increases the computational efficiency. Comparison of execution processes between the exemplary embodiment of the present disclosure and the prior art can be referred to FIG. 10a and FIG. 10d.

Based on the above-mentioned embodiment shown in FIG. 11, as shown in FIG. 15, the data acquisition module 901 can include following units:

A size reduction unit 9011 used to reduce the size of the first feature map to the same size as that of the second feature map based on the size of the second feature map when the size of the first feature map is bigger than the size of the second feature map;

In some embodiments, the size of the first feature map is bigger than the size of the second feature map. For example, the first feature map is one with a default size of 5*5 while the second feature map is one with a size of 3*3; at this time, as the next layer in the neural network does not support a feature map with a size of 5*5, the way in the present module can also be adopted apart from the above-mentioned processing ways in the segmentation unit 9021. Namely, before the division of the first feature map of the current layer, firstly inquire the size of the second feature map supported by the computation on the next layer and the example is the above-mentioned feature map with a size of 3*3. If the convolution computation of the current layer can both support the feature map with a default size of 5*5 and the feature map with a size of 3*3, the feature map with a size of 3*3 can act as the first feature map for the current layer.

A first division unit 9012 used to divide an original feature map of the current layer according to the size of the reduced first feature map.

In some embodiments, the size of the first feature map is reduced in the above-mentioned manner, and then, an original feature map is divided. At this time, the divided first feature map and the second feature map have the same size, and the above-mentioned switching unit 9025 can be used to sort the convolution order of feature maps. As the first feature map is reduced to one with the same size to the second feature map, the procedure of storing the second subfeature map into the off-chip memory is left out, which can further decrease the interlayer feature map data access overhead and can reduce the idle time of the computation unit.

Based on the above-mentioned embodiment shown in FIG. 11, as shown in FIG. 16, the data acquisition module 901 can include following units:

A size increase unit 9013 used to increase the size of the first feature map to one the same with the size of the second feature map based on the size of the second feature map when the size of the first feature map is smaller than the size of the second feature map;

In some embodiments, the size of the first feature map is smaller than the size of the second feature map. For example, the first feature map has a default size of 5*5 and the second feature map has a size of 6*6. At this time, the size of the first feature map output from the previous layer does not meet the convolution size of the second feature map for the convolution supported by the next layer. The processing way in the size increase unit 9013 can also be adopted apart from the above-mentioned processing ways in the loading unit 9023. Namely, before the division of the first feature map of the current layer, firstly inquire the size of the second feature map supported by the computation on the next layer and the example is the above-mentioned size of the feature map of 6*6. If the convolution computation of the current layer can both support the feature map with a default size of 5*5 and the feature map with a size of 6*6, the feature map with a size of 6*6 can act as the first feature map for the current layer.

A second division unit 9014 used to divide an original feature map of a current layer according to the size of the increased first feature map.

In some embodiments, the size of the first feature map is increased with the above-mentioned way, and then, the original feature map is divided. At this time, the divided first feature map have the same size as the second feature map and the above-mentioned method used by the switching unit 9025 can be adopted to sort the convolution order of feature maps. As the size of the first feature map is increased to one the same to second feature map, the procedure of loading the third feature map from the off-chip memory is left out, which can further decrease the interlayer feature map data access overhead and can reduce the idle time of the computation unit.

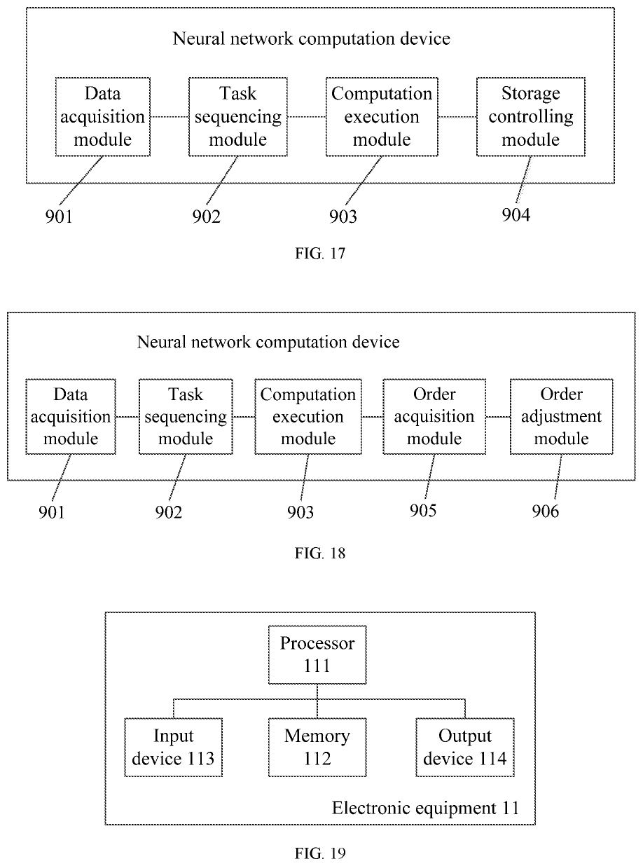

As shown in FIG. 17, based on the above-mentioned embodiment shown in FIG. 11, the neural network computation device can also comprise following modules:

A storage controlling module 904 used to store the first feature map into an on-chip cache unit.

In some embodiments, as the first feature map needs to be stored into the on-chip cache unit during the process of convolution computation, an original feature map and an output feature map will be stored in the off-chip memory. In order to store the first feature map into the on-chip cache unit, an instruction of storing the first feature map into the on-chip cache unit is executed to avoid that the first feature map is stored into the off-chip memory.

As shown in FIG. 18, based on the above-mentioned embodiment shown in FIG. 2, following modules can be further comprised:

An order acquisition module 905 used to acquire an order number of the second feature map that needs the convolution computation at present in each second feature map of the next layer;

In some embodiments, in order to decrease the interlayer access overhead, the first feature map means the first feature map output by the last executed convolution subtask in the current layer, while the second feature map means the second feature map input by the firstly executed convolution subtask in the next layer. The order number means which number of convolution subtask that its input corresponds to the second feature map in the next layer.

An order adjustment module 906 used to determine the convolution computation order of the second feature map that needs convolution computation subsequently in the next layer based on the order number of the feature map.

In some embodiments, the execution sequence for subtasks of layer L₀ is a sequential execution, that is, multiple feature maps are sequentially executed from left to right and from top to bottom. At this time, when layer L₀ executes the last subtask, it is required that the feature map in the lower right corner is convoluted and the first feature map of the last subtask is output after the convolution. At this time, the first executed subtask of layer L₁ is to perform the convolution by switching the first feature map at lower right corner into the second feature map. After the execution of the first subtask is completed, the subsequent subtasks can perform convolution either in an inverse order from right to left and bottom to top or in a random order.

In the above-mentioned exemplary embodiments, no matter what the convolution computation order is, as long as the first feature map output by the last convolution computation subtask of the previous layer acts as the second feature map for the first convolution computation subtask of the next layer by dividing or filling, or directly acts as the second feature map of the first convolution computation subtask of the next layer, computations on the storage and loading process of the first feature map can be left out and the idle time of the computation unit can be reduced. For example, still taking the computation in FIG. 1 as an example, during the computation of the current layer, the convolution order is in a convolution order of feature maps 1011, 1012, 1013, and 1014, while the output order is in an order of feature maps 1031, 1032, 1033, and 1034. Upon the computation on the next layer, there are three optional computation orders, first of which is reverse to an order performing the computation in the current layer, and performs the computation in an order of feature maps 1034, 1033, 1032, and 1031; second of which firstly computes feature map 1034 and then computes other feature maps still in the original output order, i.e. the whole computation order is in an order of feature maps 1034, 1031, 1032, and 1033; and third of which firstly computes feature map 1034 and then computes other feature maps in an random order. Actually, feature map 1034 output when computing feature map 1014 of the current layer should be firstly computed in any computation order because feature map 1034 is the last feature map in the current layer that is stored in the output over-provisioning 107. At this time, the computation on this feature map can be continued, which saves the procedure of storing this feature map into the off-chip memory and then loading it into the on-chip cache from the off-chip memory, saving the feature map data access overhead and reducing the idle time of the computation unit. Other feature maps have been stored into the off-chip memory. For example, during the process of performing convolution computation on feature map 1014, feature map1033 is stored into the off-chip memory from the output over-provisioning 107 of the on-chip cache, which reserves enough space for storing feature map 1034. There is a need to acquire the order number of the current feature map in the computation process based on above-mentioned several computation orders, so as to sort the subsequent convolution computation. For example, when performing the convolution computation with the first way, the feature map for the current convolution is feature map 1033 and its order number is second, which means the feature map that needs computation subsequently is feature map 1032.

### Exemplary Electronic Equipment

Now, an electronic equipment according to an embodiment of the present disclosure is described with reference to FIG. 19. This electronic equipment can be anyone or two of a first equipment and a second equipment or a single unit equipment separated with the first equipment and the second equipment. The single unit equipment can communicate with the first equipment and the second equipment so as to receive an input signal collected from them.

FIG. 19 shows a block diagram of an electronic equipment according to an embodiment of the present disclosure.

As shown in FIG. 19, the electronic equipment 11 comprises one or more processors 111 and memory 112.

The processor 111 can be a central processing unit (CPU) or a processing unit in other forms with data processing ability and/or instruction executing ability, and it can control other components in the electronic equipment 11 to execute the desired functions.

The memory 112 can comprises one or more computer program products which can include a computer-readable storage media in various forms, such as a volatile memory and/or a nonvolatile memory. For example, the volatile memory can include a random access memory (RAM) and/or a cache and so on. For example, the nonvolatile memory can include a read only memory (ROM), a hard disk and a flash memory and so on. One or more computer program instructions can be stored on the computer readable storage media, and can be executed by the processor 111 so as to realize the neural network computation method in each embodiment and /or other desired functions disclosed in the above-mentioned present disclosure. Various contents such as input signal, signal component and noise component can also be stored in the computer readable storage media.

In one example, the electronic equipment 11 can also comprise an input device 113 and an output device 114, and these components are mutually connected by a bus system and/or other forms of connecting mechanisms (not shown).

For example, when this electronic equipment is the first equipment or the second equipment, the input device 113 can be above-mentioned camera, which enables it to acquire the real-time images. When the electronic equipment is a single unit equipment, images stored in the equipment can be used.

Besides, the input device 113 can also comprises, for example, a keyboard and a mouse.

This output device 114 can output various information to the outside, including the determined distance information and direction information. This output device 114 can comprise, for example, a display, a speaker, a printer, a communication network and its long distance output equipment connected therewith.

Of course, for the sake of simplification, FIG. 19 only shows some components in this electronic equipment 11 that are involved in the present disclosure while omitting components such a bus and an input/output interface. Nonetheless, according to specific application environments, the electronic equipment 11 can also comprise any other suitable components.

### Exemplary Computer Program Products and a Computer Readable Storage Media

Apart from the above-mentioned method and equipment, embodiments of the present disclosure can also be computer program products including computer program instructions. The computer program instructions under the execution of a processor allow the processor to execute steps in the neural network computation method according to each embodiment of the present disclosure, which are described in the above-mentioned “exemplary method” section of the present specification.

The computer program products can compile procedure codes that are used to execute operations in embodiments of the present disclosure by using any combinations of one or more programming languages including an object oriented programming language such as Java, C++, etc. as well as a regular procedural programming language such as C language or similar programming languages. The procedure codes can be completely executed on a user computation equipment, partly executed on a user equipment, executed as an independent software package, partly executed on a user computation equipment and partly executed on a long distance equipment, or completely executed in a long distance computation equipment or a server.

Besides, embodiments of the present disclosure can also be a computer readable storage media stored with computer program instructions thereon. The computer program instructions under the execution of a processor allow the processor to execute steps in the neural network computation method according to each embodiment of the present disclosure, which are described in the above-mentioned “exemplary method” section of the present specification.

The computer readable storage media can adopt any combinations of one or more readable media. A readable media can be a readable signal media or a readable storage media. A readable storage media can include but not limited to, for example, a system, a device or an element with electricity, magnet, light, electromagnet, infrared or semiconductor, or combinations of any above-mentioned ones. More specific examples (non-exhaustive list) of a readable storage media include an electronic connection with one or more wires, a portable disc, a hard disk, a random access memory (RAM), a read only memory (ROM), an erasable and programmable read only memory (erasable programmable read-only memory (EPROM)or flash memory), fiber, a portable compact disc read only memory (CD-ROM), a light storage element, a magnet storage element, or any combinations of the above-mentioned ones.

The basic principles of the present disclosure are described above in combination with specific embodiments. However, it is necessary to point out that the merits, advantages, effects, etc. mentioned in the present disclosure are merely examples rather than limitations, which cannot be deemed to be a necessary possession for each embodiment of the present disclosure. Further, the specific details of the above-mentioned disclosure are merely for the exemplary and easy-understanding sake rather than limitations, which should not be construed that the present disclosure must be implemented using the specific details described above.

Block diagrams of the element, the device, the equipment and the system involved in the present disclosure are merely exemplary examples and do not intend or imply that they have to be connected, arranged or configured necessarily by ways shown in the block diagrams. As what a person skilled in the art can recognize, these elements, devices, equipments and systems can be connected, arranged and configured in any way. Terms such as “include”, “comprise” and “have” are open vocabularies, which mean “include but not limited to” and can be used interchangeably. The terms “or” and “and” used herein mean “and/or”, which can be used interchangeably, unless otherwise indicated in the context. The term “such as” used herein means “such as but not limited to”, which can be used interchangeably.

What needs to be pointed out is that each member or each step in the device, the equipment and the method of the present disclosure can be disintegrated or recombined. These disintegrations and/or recombination should be deemed as equivalent solutions to the present disclosure.

Descriptions of the disclosed aspects are provided to allow anyone skilled in the art able to implement or apply the present disclosure. Various modifications on these aspects are very obvious for a person skilled in the art and the general principles defined herein can be applied in other aspects without departing from the scope of the present disclosure. Therefore, the present disclosure does not intend to be limited into the aspects shown herein but rather the widest scope in consistent with the principles and novel features disclosed herein.

The above-mentioned descriptions are provided for the sake of exemplifying and describing. Besides, these descriptions do not intend to limit embodiments of the present disclosure into the forms disclosed herein. Although multiple exemplary aspects and embodiments have been discussed above, a person skilled in the art will recognize their certain transformations, modifications, additions and subcombinations.

What is claimed is:

1. A neural network computation method comprising:
determining a size of a first feature map obtained when a processor performs convolution computation on a current layer of a neural network before performing a convolution computation on a next layer in the neural network;
determining a convolution computation order of the next layer according to the size of the first feature map and a size of a second feature map for a convolution supported by the next layer; and
performing convolution computation instructions for the next layer based on the convolution computation order.

2. The method of claim 1, wherein determining the convolution computation order of the next layer according to the size of the first feature map and the size of the second feature map for the convolution supported by the next layer comprises:
when the size of the first feature map is bigger than the size of the second feature map, dividing the first feature map into a first subfeature map and a second subfeature map, based on the size of the first feature map, wherein a size of the first subfeature map is equal to the size of the second feature map; and
using the first subfeature map as the second feature map for a convolution computation type in the next layer, and storing the second subfeature map into an off-chip memory unit.

3. The method of claim 1, wherein determining the convolution computation order of the next layer according to the size of the first feature map and the size of the second feature map for the convolution supported in the next layer comprises:
when the size of the first feature map is smaller than the size of the second feature map, loading a third feature map in a domain adjacent to the first feature map from an off-chip memory; and
determining the second feature map for a convolution computation type of the next layer based on the first feature map and the third feature map.

4. The method of claim 1, wherein determining the size of the first feature map obtained when the processor performs the convolution computation on the current layer of the neural network before performing the convolution computation on the next layer in the neural network comprises:
when the size of the first feature map is bigger than the size of the second feature map, reducing the size of the first feature map to the same size of the second feature map based on the size of the second feature map; and
dividing an original feature map of the current layer according to the size of the reduced first feature map.

5. The method of claim 1, wherein determining the size of the first feature map obtained when the processor performs convolution computation on the current layer of the neural network before performing the convolution computation on the next layer in the neural network comprises:
when the size of the first feature map is smaller than the size of the second feature map, increasing the size of the first feature map to the same size of the second feature map based on the size of the second feature map; and
dividing an original feature map of the current layer according to the size of the increased first feature map.

6. The method of claim 1, wherein determining the convolution computation order of the next layer according to the size of the first feature map and the size of the second feature map for the convolution supported by the next layer comprises:
when the size of the first feature map is equal to the size of the second feature map, using the first feature map as the second feature map for a convolution computation type of the next layer.

7. The method of claim 1, wherein the method further comprises:
acquiring an order number of the second feature map that needs the convolution computation among second feature maps in the next layer; and
determining a convolution computation order of the second feature map that subsequently needs the convolution computation in the next layer based on the order number of the feature map.

8. A non-transitory computer-readable storage medium, comprising computer programs, when executed by a computer device, causes the computer device to:
determine a size of a first feature map obtained when a processor performs convolution computation on a current layer of a neural network before performing a convolution computation on a next layer in the neural network;
determine a convolution computation order of the next layer according to the size of the first feature map and a size of a second feature map for a convolution supported by the next layer; and
perform convolution computation instructions for the next layer based on the convolution computation order.

9. The non-transitory computer-readable storage medium of claim 8, further comprising computer programs, when executed by the computer device, make the computer device to:
when the size of the first feature map is bigger than the size of the second feature map, divide the first feature map into a first subfeature map and a second subfeature map, based on the size of the first feature map, wherein a size of the first subfeature map is equal to the size of the second feature map; and
use the first subfeature map as the second feature map for a convolution computation type in the next layer, and storing the second subfeature map into an off-chip memory unit.

10. The non-transitory computer-readable storage medium of claim 8, further comprising computer programs, when executed by the computer device, make the computer device to:
when the size of the first feature map is smaller than the size of the second feature map, load a third feature map in a domain adjacent to the first feature map from an off-chip memory; and
determine the second feature map for a convolution computation type of the next layer based on the first feature map and the third feature map.

11. The non-transitory computer-readable storage medium of claim 8, further comprising computer programs, when executed by the computer device, make the computer device to:
when the size of the first feature map is bigger than the size of the second feature map, reduce the size of the first feature map to the same size of the second feature map based on the size of the second feature map; and
divide an original feature map of the current layer according to the size of the reduced first feature map.

12. The non-transitory computer-readable storage medium of claim 8, further comprising computer programs, when executed by the computer device, make the computer device to:
when the size of the first feature map is smaller than the size of the second feature map, increase the size of the first feature map to the same size of the second feature map based on the size of the second feature map; and
divide an original feature map of the current layer according to the size of the increased first feature map.

13. The non-transitory computer-readable storage medium of claim 8, further comprising computer programs, when executed by the computer device, make the computer device to:
when the size of the first feature map is equal to the size of the second feature map, use the first feature map as the second feature map for a convolution computation type of the next layer.

14. The non-transitory computer-readable storage medium of claim 8, further comprising computer programs, when executed by the computer device, make the computer device to:
acquire an order number of the second feature map that needs the convolution computation among second feature maps in the next layer; and
determine a convolution computation order of the second feature map that subsequently needs the convolution computation in the next layer based on the order number of the feature map.

15. An electronic equipment comprising
a processor programmed to
determine a size of a first feature map obtained when the processor performs convolution computation on a current layer of a neural network before performing a convolution computation on a next layer in the neural network;
determine a convolution computation order of the next layer according to the size of the first feature map and a size of a second feature map for a convolution supported by the next layer; and
perform convolution computation instructions for the next layer based on the convolution computation order.

16. The electronic equipment of claim 15, wherein the processor is further programmed to:
when the size of the first feature map is bigger than the size of the second feature map, divide the first feature map into a first subfeature map and a second subfeature map, based on the size of the first feature map, wherein a size of the first subfeature map is equal to the size of the second feature map; and use the first subfeature map as the second feature map for a convolution computation type in the next layer, and storing the second subfeature map into an off-chip memory unit; or
when the size of the first feature map is smaller than the size of the second feature map, load a third feature map in a domain adjacent to the first feature map from an off-chip memory; and determine the second feature map for a convolution computation type of the next layer based on the first feature map and the third feature map.

17. The electronic equipment of claim 15, wherein the processor is further programmed to:
when the size of the first feature map is bigger than the size of the second feature map, reduce the size of the first feature map to the same size of the second feature map based on the size of the second feature map; and divide an original feature map of the current layer according to the size of the reduced first feature map.

18. The electronic equipment of claim 15, the processor is further programmed to:
when the size of the first feature map is smaller than the size of the second feature map, increase the size of the first feature map to the same size of the second feature map based on the size of the second feature map; and
divide an original feature map of the current layer according to the size of the increased first feature map.

19. The electronic equipment of claim 15, wherein the processor is further programmed to:
when the size of the first feature map is equal to the size of the second feature map, use the first feature map as the second feature map for a convolution computation type of the next layer.

20. The electronic equipment of claim 15, wherein the processor is further programmed to:
acquire an order number of the second feature map that needs the convolution computation among second feature maps in the next layer; and
determine a convolution computation order of the second feature map that subsequently needs the convolution computation in the next layer based on the order number of the feature map.
